(19) United States
(12) Patent Application Publication
(10) Pub. No.: US 2004/0089294 A1
(43) Pub. Date: May 13, 2004

(54) Diaphragm holder for pressure regulator of air tank used in diving

(76) Inventor: Hsing-Chi Hsieh, Taipei (TW)

Correspondence Address: PRO-TECHTOR INTERNATIONAL, 20775 Norada Court, Saratoga, CA, 95070-3018, US

(21) Appl. No.: 10/293,010

(22) Filed: Nov. 12, 2002

(51) Int. Cl. A62B 18/10; B63C 11/02

(52) U.S. Cl. 128/201.27; 128/201.26; 128/201.28

(57) ABSTRACT

A diaphragm holder for pressure regulator of air tank used in diving includes a diaphragm seat formed on the pressure regulator for holding a rubber diaphragm therein, a cover for closing onto a top of the diaphragm seat, and a soft push member integrally formed on the cover. The diaphragm seat is provided on an outer wall surface with spaced raised rails, and the cover is provided on an inner wall surface with L-shaped grooves corresponding to the raised rails on the diaphragm seat. Each of the L-shaped grooves includes communicable wide and narrow groove portions. By closing the cover to the diaphragm seat with the wide groove portions aligned with the raised rails and turning the cover, the rails are moved into the narrow groove portions to lock the cover to the diaphragm seat with the soft push member correctly located at an outer side of the rubber diaphragm.

### BACKGROUND OF THE INVENTION

The present invention relates to a diaphragm holder for pressure regulator of air tank used in diving, and more particularly to a diaphragm holder for pressure regulator of air tank used in diving that can be easily assembled and disassembled and is practical for use.

A pressure regulator of air tank used in diving typically includes a rubber diaphragm, a lever, a spring, an air supply valve, a one-way valve leaf, etc., and has an outer case generally made of a rigid plastic material. When a diver inhales, air inside the pressure regulator decreases to cause reduction of internal pressure of the regulator, and the rubber diaphragm on the pressure regulator is forced by external pressure to bend inward and therefore presses against the lever, causing the lever to pull the spring and open the air supply valve. When the air supply valve is opened, air in the air tank is sent to the diver.

On the other hand, when the diver exhales, air pressure inside the regulator increases to push the rubber diaphragm outward, and the lever is moved to a normal position to release the spring and close the air supply valve. The exhaled air is discharged from the regulator via the one-way valve leaf.

The above-mentioned rubber diaphragm is mounted in a diaphragm seat formed on the outer case of the pressure regulator. A cover is fitted onto the diaphragm seat to always keep a soft push member at an outer side of the rubber diaphragm. When the diver wants to inhale an increased amount of air, he or she may use fingers to press the soft push member and thereby forces the rubber diaphragm to bend inward. The inward bent rubber diaphragm would then press against the lever and the spring to open the air supply valve, allowing air in the air tank to continuously flow into the pressure regulator and drawn in by the diver.

FIGS. 1 and 2 are exploded and assembled perspective views, respectively, of a conventional diaphragm holder for pressure regulator 1 of air tank used in diving. The pressure regulator 1 has an outer case, on which a diaphragm seat 11 is formed for a rubber diaphragm 4 to mount therein. The diaphragm seat 11 is provided on an inner wall surface with internal threads 12. A ring-shaped cover 14 having external threads 15 provided on an outer wall surface is adapted to screw into the diaphragm seat 11 with the external threads 15 meshed with the internal threads 12. A soft push member 13 is tightly fitted in the ring-shaped cover 14 to always locate at an outer side of the rubber diaphragm 4. When the soft push member 13 is inward pressed, the rubber diaphragm 4 is forced to bend inward at the same time. The soft push member 13 is provided with a plurality of openings 16, via which external pressure is guided to act on the rubber diaphragm 4 when the diver inhales in a normal manner, causing the rubber diaphragm 4 to bend inward. Moreover, the soft push member 13 is usually printed or engraved with, for example, a trademark or other mark 17. When the soft push member 13 is fitted on the cover 14 to locate at the outer side of the rubber diaphragm 4, it is normally required to keep the trademark or mark 17 at a correctly centered position relative to the ring-shaped cover 14 without biasing, so as to maintain a good quality of the pressure regulator 1 in its appearance.

The following drawbacks are found in the above-described conventional pressure regulator 1 and the manner in which the diaphragm seat 11, the cover 14, and the soft push member 13 are connected to one another:

1. The cover 14 is connected to the seat 11 by means of screwing, and it is necessary for the external threads 15 of the cover 14 to fully screw into the internal threads 12 of the seat 11 to ensure a firm connection of the cover 14 to the seat 11. Since the travel of screwing is long, it is not easy to assemble and disassemble the cover 14 to and from the seat 11 quickly.

2. The soft push member 13 is locked to the outer side of the rubber diaphragm 4 when the cover 14 is screwed into the seat 11. However, the soft push member 13 tends to displace due to a rotating force of the cover 14 when the latter is screwed into the seat 11, resulting in a biased surface mark 17. The soft push member 13 and the cover 14 must be frequently adjusted to keep the surface mark 17 at a correctly centered position. And such adjustment is time-consuming and troublesome.

3. There is only very limited area on the outer wall surface of the cover 14 for a user to hold at when the user screws the cover 14 into the seat 11. That is, the cover 14 could not be inconveniently turned to screw into the seat 11.

FIG. 3 is an exploded perspective view of another conventional diaphragm holder for pressure regulator 2 of air tank used in diving. The pressure regulator 2 was developed in an attempt to improve the pressure regulator 1 shown in FIGS. 1 and 2, and mainly includes a diaphragm seat 21 having a threaded hole 22 provided at one side at a suitable position, a soft push member 23 having a through hole 25 formed at a position corresponding to the threaded hole 22, and a ring-shaped cover 24 having a through hole 26 provided on an outer wall at a position corresponding to the threaded hole 22. Bt threading a screw 27 through the threaded hole 22 to extend into the through holes 26 and 25, the push member 23 could be accurately mounted in the ring-shaped cover 24 with a mark on the surface of the push member 23 located at a correct position relative to the pressure regulator 2. However, it is still very inconvenient to screw the cover 24 into the seat 21, and there are times the soft push member 23 still requires adjustment in its position on the cover 24.

In brief, in either case of the above two conventional pressure regulators 1 and 2, the soft push member 13 or 23 is subjected to an external force during the process of screwing the cover 14, 24 into the seat 11, 21 and therefore tends to bias. Frequent adjustment of the push member 13, 23 is therefore required. Moreover, since the outer wall surface of the cover 14, 24 is screwed into the seat 11, 21 to conceal therein, there is only very limited area on the cover 14, 24 that is exposed to outside available for holding by a user. The user has to take time and special carefulness to complete screwing of the cover 14, 24 into the seat 11, 21.

### SUMMARY OF THE INVENTION

A primary object of the present invention is to provide an improved diaphragm holder for pressure regulator of air tank used in diving to eliminate drawbacks existed in the conventional diaphragm holders.

To achieve the above and other objects, the diaphragm holder for pressure regulator of air tank used in diving according to the present invention mainly includes a diaphragm seat formed on an outer case of the pressure regulator for holding a rubber diaphragm therein, a cover for closing onto a top of the seat, and a soft push member integrally formed on the cover. The seat is provided on an outer wall surface with spaced raised rails, and the cover is provided on an inner wall surface with L-shaped grooves corresponding to the raised rails on the seat. Each of the L-shaped grooves includes a wide groove portion adapted to receive the raised rail, and a narrow groove portion integrally extended from an end of the wide groove portion for the raised rail to slide thereinto. By closing the cover to the seat with the wide groove portions aligned with the raised rails and turning the cover, the rails are moved into the narrow groove portions to lock the cover to the seat with the soft push member correctly located at an outer side of the rubber diaphragm.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional diaphragm holder for pressure regulator of air tank used in diving;

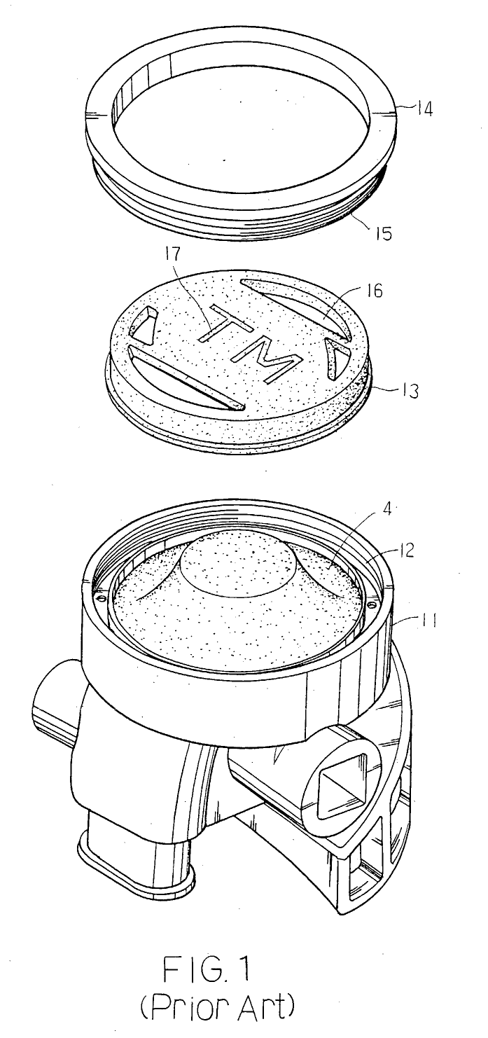

FIG. 2 is an assembled perspective view of FIG. 1;

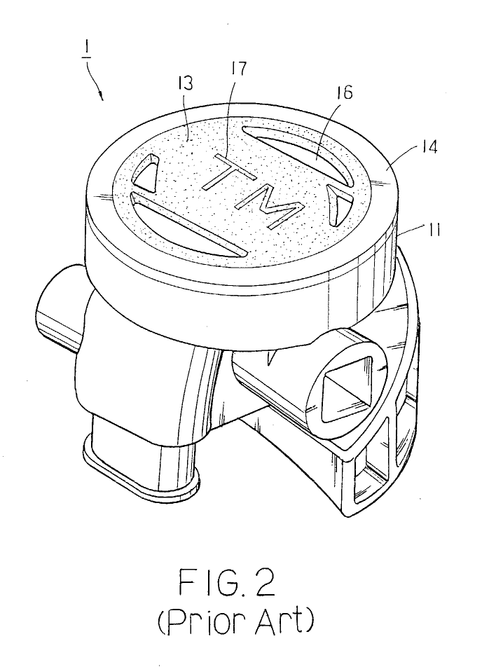

FIG. 3 is an exploded perspective view of another conventional diaphragm holder for pressure regulator of air tank used in diving;

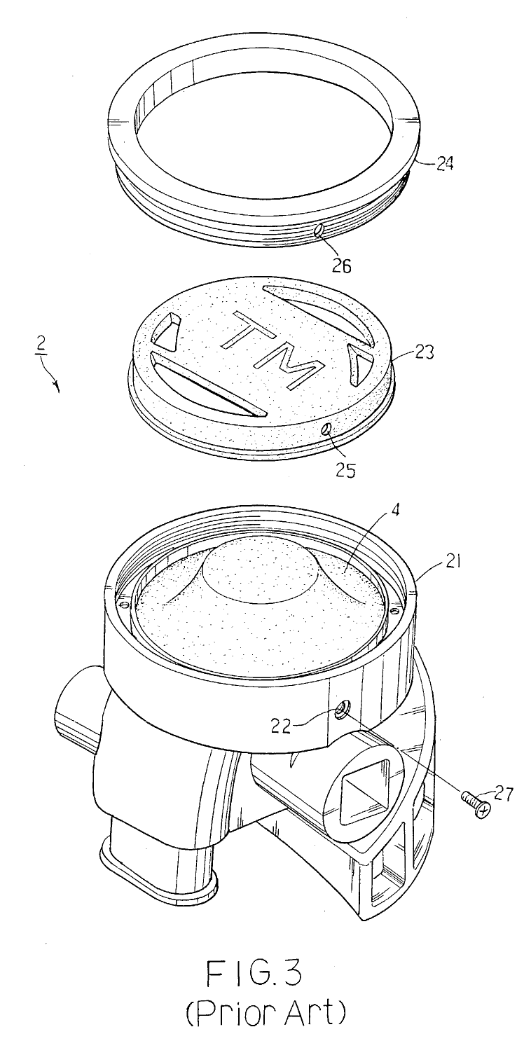

FIG. 4 is an exploded perspective view of a diaphragm holder for pressure regulator of air tank used in diving according to the present invention; and

FIG. 5 is an assembled perspective view of FIG. 4.

### DETAILED DESCRIPTION OF THE PREFERRED EMBODIMENTS

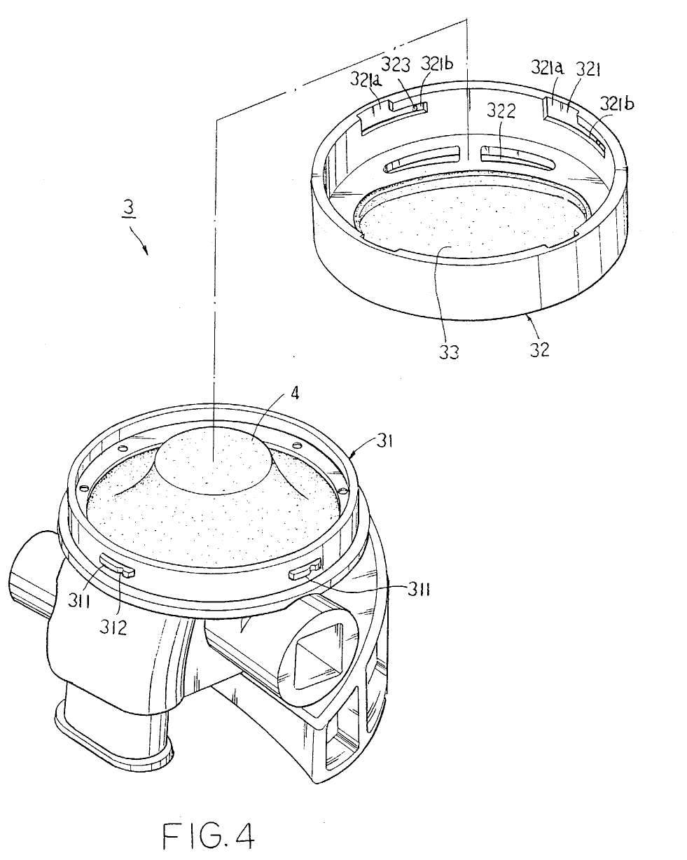

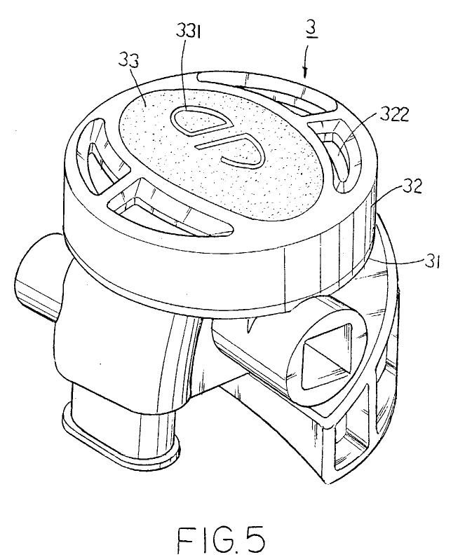

Please refer to FIGS. 4 and 5 that are exploded and assembled perspective views, respectively, of a diaphragm holder for a pressure regulator 3 of an air tank used in diving according to the present invention. As shown, the diaphragm holder mainly includes a diaphragm seat 31 formed on an outer case of the pressure regulator 3 for a rubber diaphragm 4 to mount therein, a cover 32 mounted on a top of the diaphragm seat 31, and a soft push member 33 located at an outer side of the rubber diaphragm 4 mounted in the diaphragm seat 31.

The diaphragm seat 31 is provided on an outer wall surface with a plurality of spaced raised rails 311, and the cover 32 is provided on an inner wall surface with a plurality of L-shaped grooves 321 corresponding to the raised rails 311 on the diaphragm seat 31. Each of the L-shaped grooves 321 includes a wide groove portion 321a and a narrow groove portion 321b integrally extended from one end of the wide groove portion 321a to be communicable with the latter. The soft push member 33 is located on the cover 32, and openings 322 are formed on the cover 32 and/or the soft push member 33 for guiding external pressure to act on the rubber diaphragm 4.

To assemble the cover 32 to the diaphragm seat 31, first close the cover 32 onto the diaphragm seat 31 with the wide groove portions 321a of the L-shaped grooves 321 on the cover 32 aligned with the raised rails 311 on the diaphragm seat 31, and turn the cover 32 by a small distance for the raised rails 311 to slide from the wide groove portions 321a into the narrow groove portions 321b, so that the cover 32 is locked to the diaphragm seat 31. To open the cover 32, first turn the cover 32 in a reverse direction for the raised rails 311 to move from the narrow groove portions 321b into the wide groove portions 3121a, and the cover 32 could be easily removed from the diaphragm seat 31.

From the above description, it is known the cover 32 is locked to the diaphragm seat 31 by engaging the L-shaped grooves 321 on the inner wall surface of the cover 32 with the raised rails 311 on the outer wall surface of the diaphragm seat 31. The cover 32 can therefore be designed to have an increased outer wall surface completely available for holding by a user during turning and assembling the cover 32 to the diaphragm seat 31. The increased outer wall surface of the cover 32 allows the user to hold the cover 32 in a comfortable manner while turning the cover 32 to assemble or disassemble the diaphragm holder.

Moreover, each of the raised rails 311 on the diaphragm seat 31 is provided with a recess 312, and each of the narrow groove portions 321b on the cover 32 is provided with a protuberance 323 corresponding to the recess 312. When the cover 32 is fully locked to the diaphragm seat 31, the protuberances 323 separately move into the recesses 312 with a click that clearly indicates the cover 32 and the diaphragm seat 31 have been securely locked to each other.

The soft push member 33 may be separately molded and then mounted onto the cover 32, or be integrally formed on the cover 32. In the latter case, a mark 331 shown on a top surface of the soft push member 33 is always located at a correct and unbiased position when the cover 32 is fully locked to the diaphragm seat 31. No adjustment of the soft push member 33 relative to the pressure regulator 3 is needed.

What is claimed is:

1. A diaphragm holder for pressure regulator of air tank used in diving, comprising:
a diaphragm seat being formed on an outer case of said pressure regulator for holding a rubber diaphragm therein, and being provided on an outer wall surface with a plurality of spaced raised rails;
a cover for closing onto a top of said diaphragm seat and being provided on an inner wall surface with a plurality of L-shaped grooves corresponding to said raised rails on said diaphragm seat, each of said L-shaped grooves including a wide groove portion and a narrow groove portion integrally extended from one side of said wide groove portion to communicate with the latter, said wide groove portion being adapted to receive said raised rail on said diaphragm seat when said cover is closed onto said diaphragm seat, and turning of said cover allowing said raised rails in said wide groove portions to slide into said narrow groove portions to lock said cover to said diaphragm seat; and
a soft push member fitted in said cover to locate at an outer side of said rubber diaphragm in said diaphragm seat when said cover is locked to said diaphragm seat.

2. The diaphragm holder for pressure regulator of air tank used in diving as claimed in claim 1, wherein each of said raised rails on said diaphragm seat is provided with a recess, and each of said narrow groove portions on said cover is provided with a protuberance corresponding to said recess, whereby said protuberances separately engage with said recesses when said cover is fully locked to said diaphragm seat.

3. The diaphragm holder for pressure regulator of air tank used in diving as claimed in claim 1, wherein said cover and said soft push member are integrally molded to form one integral body.

4. The diaphragm holder for pressure regulator of air tank used in diving as claimed in claim 1, wherein at least one of said cover and said soft push member is provided with openings.
